(19) United States
(12) Patent Application Publication
(10) Pub. No.: US 2026/0134030 A1
(43) Pub. Date: May 14, 2026

(54) Webpage Media Playback

(71) Applicant: Sonos, Inc., Goleta, CA (US)

(72) Inventors: Ted M. Lin, Ayer, MA (US); Eric M. Bass, Leominster, MA (US)

(21) Appl. No.: 19/355,841

(22) Filed: Oct. 10, 2025

Related U.S. Application Data
(63) Continuation of application No. 18/452,857, filed on Aug. 21, 2023, now Pat. No. 12,443,653.
Application No. 18/452,857 is a continuation of application No. 17/006,972, filed on Aug. 31, 2020, now Pat. No. 11,782,977.
Application No. 17/006,972 is a continuation of application No. 15/612,126, filed on Jun. 2, 2017, now Pat. No. 10,762,129.
Application No. 15/612,126 is a continuation of application No. 14/197,403, filed on Mar. 5, 2014, now Pat. No. 9,679,054.

(51) Int. Cl. G06F 16/638; G06F 3/0481; G06F 3/0482; G06F 16/438; H04N 21/436

(52) U.S. Cl. CPC G06F 16/638; G06F 3/0481; G06F 3/0482; G06F 16/438; G06F 16/4393; G06F 16/639; H04N 21/43615

(57) ABSTRACT

Examples described herein involve facilitating playback of media content via a webpage. An example implementation involves a computing device: identifying one or more playback zones including at least one respective playback device; transmitting, via a web browser, a webpage request; receiving a webpage that includes a link to a media item; modifying the received webpage to include a representation associated with the link; causing, via the web browser, display of the modified webpage; responsive to a selection of the representation, causing display of the option; and responsive to a selection of the option, causing display of a list of the one or more playback zones, wherein at least one playback zone of the one or more playback zones is selectable to cause the media item to be added to the playback queue associated with the at least one playback zone.

### CROSS REFERENCE TO RELATED APPLICATIONS

This application is a continuation of U.S. patent application Ser. No. 18/452,857, filed on Aug. 21, 2023, which is a continuation of U.S. patent application Ser. No. 17/006,972, filed on Aug. 31, 2020, issued as U.S. Pat. No. 11,782,977 on Oct. 10, 2023, which is a continuation of U.S. patent application Ser. No. 15/612,126, filed on Jun. 2, 2017, issued as U.S. Pat. No. 10,762,129 on Sep. 1, 2020, which is a continuation of U.S. patent application Ser. No. 14/197,403, filed on Mar. 5, 2014, issued as U.S. Pat. No. 9,679,054 on Jun. 13, 2017, each of which is incorporated herein by reference in its entirety.

### FIELD OF THE DISCLOSURE

The disclosure is related to consumer goods and, more particularly, to methods, systems, products, features, services, and other elements directed to media playback or some aspect thereof.

### BACKGROUND

Options for accessing and listening to digital audio in an out-loud setting were severely limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from virtually unlimited sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

Given the ever growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows an example media playback system configuration in which certain embodiments may be practiced;

FIG. 2 shows a functional block diagram of an example playback device;

FIG. 3 shows a functional block diagram of an example control device;

FIG. 4 shows an example controller interface;

FIG. 5 shows an example flow diagram for facilitating playback of media items on a webpage by a playback zone of a media playback system; and

FIGS. 6A, 6B, 6C, and 6D show example webpage representations with playable media items.

The drawings are for the purpose of illustrating example embodiments, but it is understood that the inventions are not limited to the arrangements and instrumentality shown in the drawings.

### DETAILED DESCRIPTION

### I. Overview

Embodiments described herein involve the playback of media items from a webpage by a playback zone of a media playback system. In one embodiment, playback zones in a media playback system are identified when a web-browsing interface is launched. When a webpage is displayed on the web-browsing interface, one or more links to playable media items on the webpage are identified, and the webpage is modified such that one or more representations corresponding to the one or more links are selectable to cause the respective playback media items to be played by one or more of the identified playback zones.

In one example, a selection of a representation will prompt a display of the identified playback zones from which the user can choose a playback zone to play the corresponding media item. In another example, the media item may be added to a playback queue associated with the selected playback zone in addition to, or instead of being immediately played by the selected playback zone.

As indicated above, the present application involves facilitating playback of media items on a webpage by a playback zone of a media playback system. In one aspect, a method is provided. The method involves identifying one or more playback zones of a media playback system upon opening a web-browsing interface, identifying on a webpage, a link to a playable media item, and modifying the webpage such that a representation associated with the link is selectable to cause the media item to be played in the one or more playback zones.

In another aspect, a device is provided. The device includes a processor, and memory having stored thereon instructions executable by the processor to cause the device to perform functions. The functions include identifying one or more playback zones of a media playback system upon opening a web-browsing interface, identifying on a webpage, a link to a playable media item, and modifying the webpage such that a representation associated with the link is selectable to cause the media item to be played in the one or more playback zones.

In yet another aspect, a non-transitory computer readable memory is provided. The non-transitory computer readable memory has stored thereon instructions executable by a computing device to cause the computing device to perform functions. The functions include identifying one or more playback zones of a media playback system upon opening a web-browsing interface, identifying on a webpage, a link to a playable media item, and modifying the webpage such that a representation associated with the link is selectable to cause the media item to be played in the one or more playback zones.

The present application further involves playing media items on a webpage in a playback zone of a media playback system. In one aspect, a method is provided. The method involves displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The method also involves causing the particular playback zone to play the media item responsive to a second input indicating a selection of a particular playback zone in the list of one or more playback zones.

In another aspect, a device is provided. The device includes a processor, and memory having stored thereon instructions executable by the processor to cause the device to perform functions. The functions include displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The functions also include causing the particular playback zone to play the media item responsive to a second input indicating a selection of a particular playback zone in the list of one or more playback zones.

In yet another aspect, a non-transitory computer readable memory is provided. The non-transitory computer readable memory has stored thereon instructions executable by a computing device to cause the computing device to perform functions. The functions include displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The functions also include causing the particular playback zone to play the media item responsive to a second input indicating a selection of a particular playback zone in the list of one or more playback zones.

It will be understood by one of ordinary skill in the art that this disclosure includes numerous other embodiments.

### II. Example Operating Environment

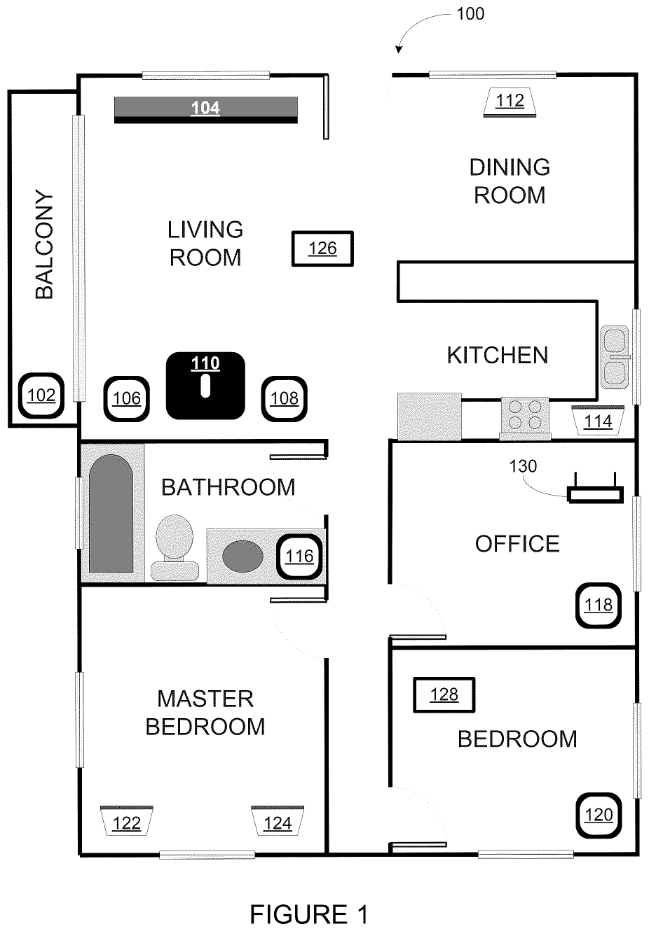

FIG. 1 shows an example configuration of a media playback system 100 in which one or more embodiments disclosed herein may be practiced or implemented. The media playback system 100 as shown is associated with an example home environment having several rooms and spaces, such as for example, a master bedroom, an office, a dining room, and a living room. As shown in the example of FIG. 1, the media playback system 100 includes playback devices 102-124, control devices 126 and 128, and a wired or wireless network router 130.

Further discussions relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

### a. Example Playback Devices

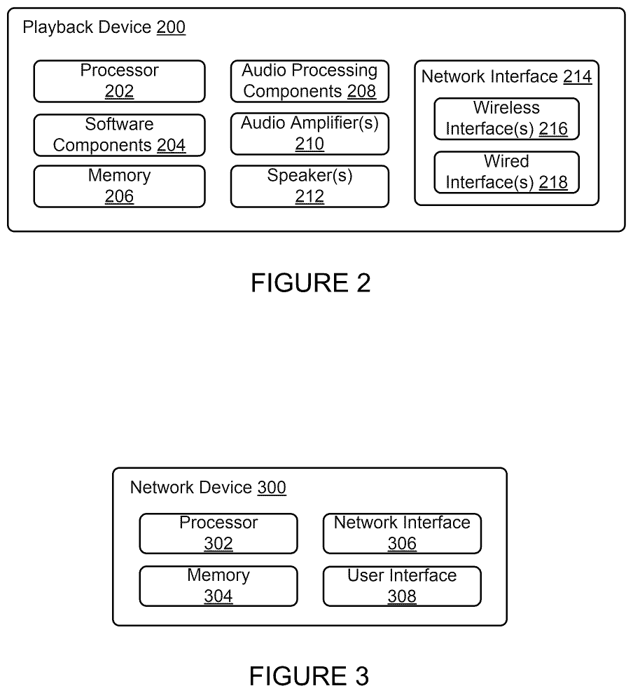

FIG. 2 shows a functional block diagram of an example playback device 200 that may be configured to be one or more of the playback devices 102-124 of the media playback system 100 of FIG. 1. The playback device 200 may include a processor 202, software components 204, memory 206, audio processing components 208, audio amplifier(s) 210, speaker(s) 212, and a network interface 214 including wireless interface(s) 216 and wired interface(s) 218. In one case, the playback device 200 may not include the speaker(s) 212, but rather a speaker interface for connecting the playback device 200 to external speakers. In another case, the playback device 200 may include neither the speaker(s) 212 nor the audio amplifier(s) 210, but rather an audio interface for connecting the playback device 200 to an external audio amplifier or audio-visual receiver.

In one example, the processor 202 may be a clock-driven computing component configured to process input data according to instructions stored in the memory 206. The memory 206 may be a tangible computer-readable medium configured to store instructions executable by the processor 202. For instance, the memory 206 may be data storage that can be loaded with one or more of the software components 204 executable by the processor 202 to achieve certain functions. In one example, the functions may involve the playback device 200 retrieving audio data from an audio source or another playback device. In another example, the functions may involve the playback device 200 sending audio data to another device or playback device on a network. In yet another example, the functions may involve pairing of the playback device 200 with one or more playback devices to create a multi-channel audio environment.

Certain functions may involve the playback device 200 synchronizing playback of audio content with one or more other playback devices. During synchronous playback, a listener will preferably not be able to perceive time-delay differences between playback of the audio content by the playback device 200 and the one or more other playback devices. U.S. Pat. No. 8,234,395 entitled, “System and method for synchronizing operations among a plurality of independently clocked digital data processing devices,” which is hereby incorporated by reference, provides in more detail some examples for audio playback synchronization among playback devices.

The memory 206 may further be configured to store data associated with the playback device 200, such as one or more zones and/or zone groups the playback device 200 is a part of, audio sources accessible by the playback device 200, or a playback queue that the playback device 200 (or some other playback device) may be associated with. The data may be stored as one or more state variables that are periodically updated and used to describe the state of the playback device 200. The memory 206 may also include the data associated with the state of the other devices of the media system, and shared from time to time among the devices so that one or more of the devices have the most recent data associated with the system. Other embodiments are also possible.

The audio processing components 208 may include one or more digital-to-analog converters (DAC), an audio preprocessing component, an audio enhancement component or a digital signal processor (DSP), and so on. In one embodiment, one or more of the audio processing components 208 may be a subcomponent of the processor 202. In one example, audio content may be processed and/or intentionally altered by the audio processing components 208 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback by the playback device 200, the audio processing components 208 may be configured to process audio content to be sent to one or more other playback devices for playback.

Audio content to be processed and/or played back by the playback device 200 may be received from an external source, such as via an audio line-in input connection (e.g., an auto-detecting 3.5 mm audio line-in connection) or the network interface 214.

The network interface 214 may be configured to facilitate a data flow between the playback device 200 and one or more other devices on a data network. As such, the playback device 200 may be configured to receive audio content over the data network from one or more other playback devices in communication with the playback device 200, network devices within a local area network, or audio content sources over a wide area network such as the Internet. In one example, the audio content and other signals transmitted and received by the playback device 200 may be transmitted in the form of digital packet data containing an Internet Protocol (IP)-based source address and IP-based destination addresses. In such a case, the network interface 214 may be configured to parse the digital packet data such that the data destined for the playback device 200 is properly received and processed by the playback device 200.

As shown, the network interface 214 may include wireless interface(s) 216 and wired interface(s) 218. The wireless interface(s) 216 may provide network interface functions for the playback device 200 to wirelessly communicate with other devices (e.g., other playback device(s), speaker(s), receiver(s), network device(s), control device(s) within a data network the playback device 200 is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 218 may provide network interface functions for the playback device 200 to communicate over a wired connection with other devices in accordance with a communication protocol (e.g., IEEE 802.3). While the network interface 214 shown in FIG. 2 includes both wireless interface(s) 216 and wired interface(s) 218, the network interface 214 may in some embodiments include only wireless interface(s) or only wired interface(s).

In one example, the playback device 200 and one other playback device may be paired to play two separate audio components of audio content. For instance, playback device 200 may be configured to play a left channel audio component, while the other playback device may be configured to play a right channel audio component, thereby producing or enhancing a stereo effect of the audio content. The paired playback devices (also referred to as “bonded playback devices”) may further play audio content in synchrony with other playback devices.

In another example, the playback device 200 may be sonically consolidated with one or more other playback devices to form a single, consolidated playback device. A consolidated playback device may be configured to process and reproduce sound differently than an unconsolidated playback device or playback devices that are paired, because a consolidated playback device may have additional speaker drivers through which audio content may be rendered. For instance, if the playback device 200 is a playback device designed to render low frequency range audio content (i.e. a subwoofer), the playback device 200 may be consolidated with a playback device designed to render full frequency range audio content. In such a case, the full frequency range playback device, when consolidated with the low frequency playback device 200, may be configured to render only the mid and high frequency components of audio content, while the low frequency range playback device 200 renders the low frequency component of the audio content. The consolidated playback device may further be paired with a single playback device or yet another consolidated playback device.

By way of illustration, SONOS, Inc. presently offers (or has offered) for sale certain playback devices including a “PLAY: 1,” “PLAY: 3,” “PLAY: 5,” “PLAYBAR,” “CONNECT: AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2 or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

### b. Example Playback Zone Configurations

Referring back to the media playback system 100 of FIG. 1, the environment may have one or more playback zones, each with one or more playback devices. The media playback system 100 may be established with one or more playback zones, after which one or more zones may be added, or removed to arrive at the example configuration shown in FIG. 1. Each zone may be given a name according to a different room or space such as an office, bathroom, master bedroom, bedroom, kitchen, dining room, living room, and/or balcony. In one case, a single playback zone may include multiple rooms or spaces. In another case, a single room or space may include multiple playback zones.

As shown in FIG. 1, the balcony, dining room, kitchen, bathroom, office, and bedroom zones each have one playback device, while the living room and master bedroom zones each have multiple playback devices. In the living room zone, playback devices 104, 106, 108, and 110 may be configured to play audio content in synchrony as individual playback devices, as one or more bonded playback devices, as one or more consolidated playback devices, or any combination thereof. Similarly, in the case of the master bedroom, playback devices 122 and 124 may be configured to play audio content in synchrony as individual playback devices, as a bonded playback device, or as a consolidated playback device.

In one example, one or more playback zones in the environment of FIG. 1 may each be playing different audio content. For instance, the user may be grilling in the balcony zone and listening to hip hop music being played by the playback device 102 while another user may be preparing food in the kitchen zone and listening to classical music being played by the playback device 114. In another example, a playback zone may play the same audio content in synchrony with another playback zone. For instance, the user may be in the office zone where the playback device 118 is playing the same rock music that is being playing by playback device 102 in the balcony zone. In such a case, playback devices 102 and 118 may be playing the rock music in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified, and in some embodiments, the media playback system 100 supports numerous configurations. For instance, if a user physically moves one or more playback devices to or from a zone, the media playback system 100 may be reconfigured to accommodate the change(s). For instance, if the user physically moves the playback device 102 from the balcony zone to the office zone, the office zone may now include both the playback device 118 and the playback device 102. The playback device 102 may be paired or grouped with the office zone and/or renamed if so desired via a control device such as the control devices 126 and 128. On the other hand, if the one or more playback devices are moved to a particular area in the home environment that is not already a playback zone, a new playback zone may be created for the particular area.

Further, different playback zones of the media playback system 100 may be dynamically combined into zone groups or split up into individual playback zones. For instance, the dining room zone and the kitchen zone 114 may be combined into a zone group for a dinner party such that playback devices 112 and 114 may render audio content in synchrony. On the other hand, the living room zone may be split into a television zone including playback device 104, and a listening zone including playback devices 106, 108, and 110, if the user wishes to listen to music in the living room space while another user wishes to watch television.

### c. Example Control Devices

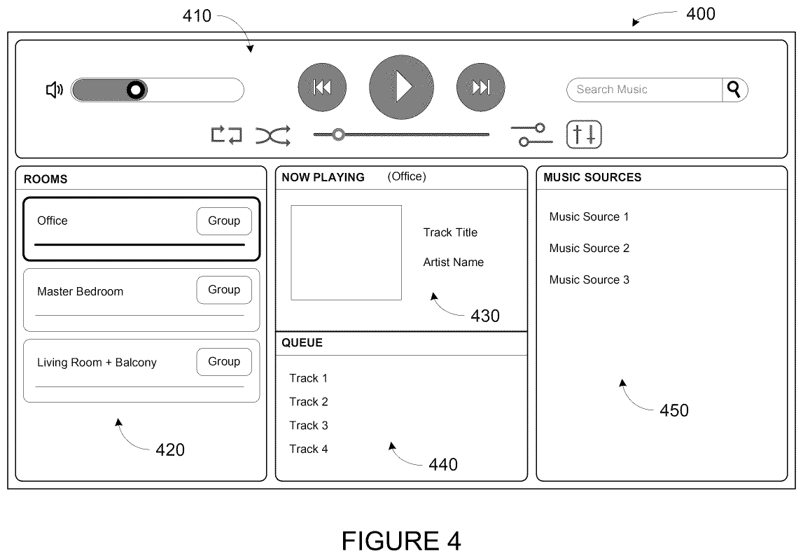

FIG. 3 shows a functional block diagram of an example control device 300 that may be configured to be one or both of the control devices 126 and 128 of the media playback system 100. As shown, the control device 300 may include a processor 302, memory 304, a network interface 306, and a user interface 308. In one example, the control device 300 may be a dedicated controller for the media playback system 100. In another example, the control device 300 may be a network device on which media playback system controller application software may be installed, such as for example, an iPhone™, iPad™ or any other smart phone, tablet or network device (e.g., a networked computer such as a PC or Mac™).

The processor 302 may be configured to perform functions relevant to facilitating user access, control, and configuration of the media playback system 100. The memory 304 may be configured to store instructions executable by the processor 302 to perform those functions. The memory 304 may also be configured to store the media playback system controller application software and other data associated with the media playback system 100 and the user.

In one example, the network interface 306 may be based on an industry standard (e.g., infrared, radio, wired standards including IEEE 802.3, wireless standards including IEEE 802.11a, 802.11b, 802.11g, 802.11n, 802.11ac, 802.15, 4G mobile communication standard, and so on). The network interface 306 may provide a means for the control device 300 to communicate with other devices in the media playback system 100. In one example, data and information (e.g., such as a state variable) may be communicated between control device 300 and other devices via the network interface 306. For instance, playback zone and zone group configurations in the media playback system 100 may be received by the control device 300 from a playback device or another network device, or transmitted by the control device 300 to another playback device or network device via the network interface 306. In some cases, the other network device may be another control device.

Playback device control commands such as volume control and audio playback control may also be communicated from the control device 300 to a playback device via the network interface 306. As suggested above, changes to configurations of the media playback system 100 may also be performed by a user using the control device 300. The configuration changes may include adding/removing one or more playback devices to/from a zone, adding/removing one or more zones to/from a zone group, forming a bonded or consolidated player, separating one or more playback devices from a bonded or consolidated player, among others. Accordingly, the control device 300 may sometimes be referred to as a controller, whether the control device 300 is a dedicated controller or a network device on which media playback system controller application software is installed.

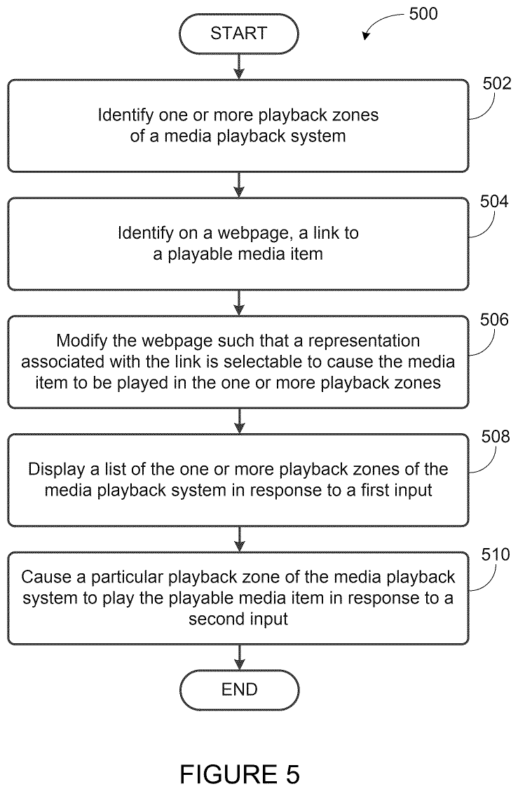

The user interface 308 of the control device 300 may be configured to facilitate user access and control of the media playback system 100, by providing a controller interface such as the controller interface 400 shown in FIG. 4. The controller interface 400 includes a playback control region 410, a playback zone region 420, a playback status region 430, a playback queue region 440, and an audio content sources region 450. The user interface 400 as shown is just one example of a user interface that may be provided on a network device such as the control device 300 of FIG. 3 (and/or the control devices 126 and 128 of FIG. 1) and accessed by users to control a media playback system such as the media playback system 100. Other user interfaces of varying formats, styles, and interactive sequences may alternatively be implemented on one or more network devices to provide comparable control access to a media playback system.

The playback control region 410 may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 410 may also include selectable icons to modify equalization settings, and playback volume, among other possibilities.

The playback zone region 420 may include representations of playback zones within the media playback system 100. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the user interface 400 are also possible. The representations of playback zones in the playback zone region 420 may be dynamically updated as playback zone or zone group configurations are modified.

The playback status region 430 may include graphical representations of audio content that is presently being played, previously played, or scheduled to play next in the selected playback zone or zone group. The selected playback zone or zone group may be visually distinguished on the user interface, such as within the playback zone region 420 and/or the playback status region 430. The graphical representations may include track title, artist name, album name, album year, track length, and other relevant information that may be useful for the user to know when controlling the media playback system via the user interface 400.

The playback queue region 440 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

Referring back to the user interface 400 of FIG. 4, the graphical representations of audio content in the playback queue region 440 may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device.

The audio content sources region 450 may include graphical representations of selectable audio content sources from which audio content may be retrieved and played by the selected playback zone or zone group. Discussions pertaining to audio content sources may be found in the following section.

### d. Example Audio Content Sources

As indicated previously, one or more playback devices in a zone or zone group may be configured to retrieve for playback audio content (e.g. according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a control device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

### III. Example Methods for Playback of Media Items on a Webpage by a Playback Zone

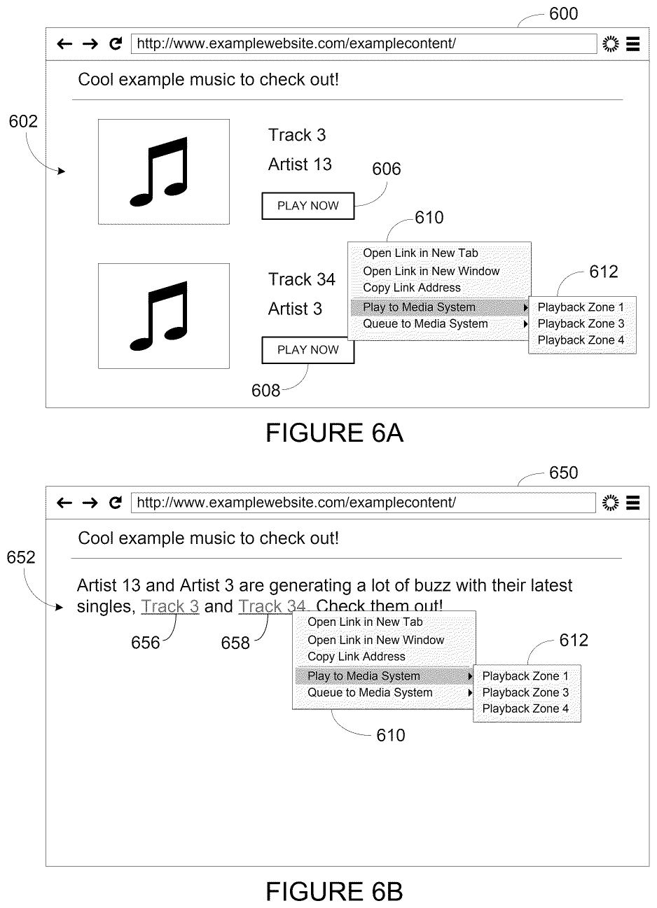

As discussed above, embodiments described herein involve playback of media items from a webpage by a playback zone of a media playback system. Method 500 shown in FIG. 5 presents an embodiment of a method for facilitating such a playback of media items. The method 500 may can be implemented within an operating environment involving, for example, the media playback system 100 of FIG. 1, one or more of the playback device 200 of FIG. 2, and one or more of the control device 300 of FIG. 3. Method 500 may include one or more operations, functions, or actions as illustrated by one or more of blocks 502-510. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the method 500 and other processes and methods disclosed herein, the flowchart shows functionality and operation of a possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the method 500 and other processes and methods disclosed herein, each block in FIG. 5 may represent circuitry that is wired to perform the specific logical functions in the process.

At block 502, the method 500 involves identifying one or more playback zones of a media playback system. In one example, the identification of the one or more playback zones may be performed upon opening or launching a web-browsing interface on a device, such as a computer or mobile device. As described above in section II, each playback zone in the media playback system may include one or more playback devices. In other example, the identification of the one or more playback zones may be performed at some time subsequent to launching the web-browsing interface. For instance, identification may occur upon selecting a media item link, or upon loading a webpage by the web-browsing interface.

In one example, each of the playback devices in the media playback system may be connected to a local area network (LAN) according to a Universal Plug and Play (UPnP) network protocol. As such, each of the playback devices in the media playback system may be discovered by other devices, including the device providing the web-browsing interface, that are also connected to the LAN according to the UPnP network protocol. The one or more playback zones in the media playback system may be identified based on the identified playback devices.

In some cases, other UPnP capable devices, such as printers, NAS devices, and televisions, among others, that are not part of the media playback system may also be discovered according to the UPnP protocol. In such cases, the process of identifying playback zones in the media playback system may further involve filtering out devices that are not part of the media playback system. For instance, devices in the media playback system may each have a device name (or device identification) that is based on a particular naming convention, and discernable from names of devices that are not part of the media playback system. As such, filtering out devices that are not part of the media playback system may involve a search for devices having device names fitting the particular naming convention of devices in the media playback system.

In another example, identification of the one or more playback zones may involve a user account of the user. For instance, the media playback system may be associated with an email address that the user provided when registering the media playback system. As such, if a user logs into the email account or otherwise provides the email address to the web-browsing interface, the media playback system associated with the email address may be identified, and accordingly, playback zones of the media playback system may also be identified. In this embodiment, the device providing the web-browsing interface may not need to be on the same network as the media playback system in order to identify the playback zones in the media playback system. Rather, the web-browsing interface device may need to have access via a wide area network (WAN) for example, to a server where account information associated with the media playback system is stored. In another case, if a controller software application for the media playback system is installed and/or launched on the device providing the web-browsing interface, identifying the playback zones of the media playback system may involve retrieving playback zone information from the controller software application.

In yet another example, identification of the one or more playback zones may involve retrieving previously stored data indicating the one or more playback zones in the media playback system. In one case, during a previous launching of the web-browsing interface, the playback zones of the media playback system were identified as described above, and data indicating the identified playback zones was stored. In one instance, the data indicating the identified playback zones may be stored in a cloud server. In another instance, the data may be stored locally on the web-browsing interface device. In a further instance, the data stored locally on the web-browsing interface device may be stored in association with the controller software application for the media playback system, as discussed above. In another case, a discovery of the playback zones, such as described above, may be performed periodically, and data indicating the identified playback zones may be stored and/or updated. In these cases, the stored data may be retrieved when the web-browsing interface is launched again. Other examples, including variations and combinations of those described above are also possible.

At block 504 in FIG. 5, the method 500 involves identifying on a webpage, a link to a playable media item. In one example, the user may access a webpage by sending a request according to a Hypertext Transfer Protocol (HTTP) by entering a URL into the web-browsing interface. In response to the request, the web-browsing interface may receive a Hypertext Markup Language (HTML) file indicating the webpage.

Identifying a link to a playable media item on the webpage may involve searching the received HTML file for references to playable media items. For instance, if the playback devices of the media playback system are capable of playing files with file extensions.wav, .m4a, and .mp3, then a search may be performed in the received HTML file for references to files having file extensions.wav, .m4a, or .mp3. One having ordinary skill in the art will understand that .wav, .m4a, and .mp3 are only example file extensions, and will appreciate that other file formats for audio and/or visual files may also be playable by devices in the media playback system and accordingly searched for when identifying links to playable media items on the webpage.

When the web-browsing interface displays the website, the link to the media item may be provided in the form of a selectable graphical or textual link representation, among others. In discussions herein, a selection of the link representation or any representation associated with a link may involve one or more mouse-clicks, finger taps or other user interactions on the representation. Other examples are also possible.

In one case, a selection of the link representation may cause media playback software to be launched to play the media item. In another case, a selection of the link representation may cause the web-browsing interface to prompt the user to indicate what the user wishes to do with the media item. For instance, a list of options may be provided for the user to select, including saving the media item, playing the media item with a particular certain media playback software, and opening the media item within the web-browsing interface using some web-browsing interface plug-in application, among other examples.

At block 506, the method involves modifying the webpage such that a representation associated with the link is selectable to cause the media item to be played in the one or more playback zones. Modifying the webpage may involve modifying the received HTML file. In one example, the webpage may be modified before the web-browsing interface displays the webpage. In other words, the web-browsing interface displays only the modified webpage and not the originally received webpage. In another example, the originally received webpage may be initially displayed by the web-browsing interface until modification of the webpage is complete, at which point the web-browsing interface may be updated with the modified webpage. Other examples are also possible.

In some embodiments, causing the media item to be played in the one or more playback zones may involve adding the media content to a playback queue associated with the one or more playback zones. For instance, the media item may be added to the playback queue prior to playback of the media item. As such, in discussions herein, a selection of the representation to cause the media item to be played in the one or more playback zones may cause the media item to be played immediately, cause the media item to be added to the playback queue, or both.

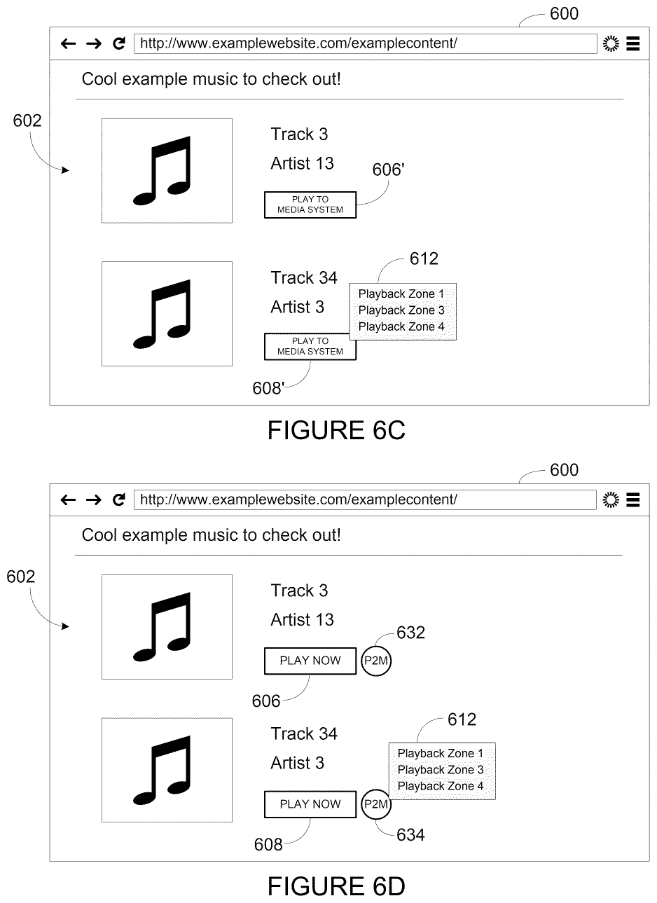

FIGS. 6A-6D shows example modified webpages 600 and 650 with representations associated with links to media items that are selectable to cause the media items to be played in one or more identified playback zones. As shown in FIG. 6A, webpage 600 includes content 602. The content 602 may include representations 606 and 608 that are selectable to cause media items corresponding to the respective representations 606 and 608 to be played in the one or more playback zones. In this example, the respective representations 606 and 608 may be in form of buttons. The representations 606 and 608 may not be visually different from link representations to the media items on the originally received webpage.

As shown, a selection of the representation 608 may cause the web-browsing interface to prompt the user to indicate what the user wishes to do with the media item by providing a list of executable options 610. The options 610 in this example may include “Open Link in New Tab,” “Open Link in New Window,” and “Copy Link Address” that may have also been available when selecting link representations on the originally received webpage. In this case, however, the options 610 also include “Play to Media System” and “Queue to Media System” which were not available when selecting link representations on the originally received webpage. As previously indicated, selecting “Play to Media System” may cause the media item corresponding to representation 608 to be played by the one or more playback zones in the media playback system, while selecting “Queue to Media System” may cause the media item corresponding to representation 608 to be added to a playback queue associated with the one or more playback zones in the media playback system. Other options that are not shown or discussed may also be in the executable options 610. Further, one having ordinary skill in the art will appreciate that while the displayed position of the options 610 appears to be proximal to the selected representation, display of the options 610 may alternatively be displayed anywhere on the web-browsing interface.

FIG. 6B shows a webpage 650 that includes textual content 652. For illustration purposes, in this example, the textual content 652 includes imbedded textual representations 656 and 658 as opposed to the button type graphical representations 606 and 608 of FIG. 6A. Nevertheless, the textual representations 656 and 658 are also selectable to cause media items corresponding to the respective textual representations 656 and 658 to be played in the one or more playback zones. Further, the representations 656 and 658 may also not be visually different from link representations to the media items on the originally received webpage, and a selection of the textual representation 656 or 658, as shown, may also cause the web-browsing interface to prompt the user to indicate what the user wishes to do with the corresponding media item by providing the list of executable options 610.

In another example, the representation associated with the link may replace the link representation on the originally received webpage to indicate that the media item can be played in the one or more playback zones. FIG. 6C shows the webpage 600 with content 602 similar to that shown in FIG. 6A. In this example, however, the representations 606′ and 608′ are visually different from the representations 606 and 608 of FIG. 6A, and accordingly different from the link representations to the media items on the originally received webpage. In other words, in this example, the representations 606′ and 608′ replace the link representations on the originally received webpage. As shown, the representations 606′ and 608′ may be in the form of buttons with text “Play to Media System” (instead of “Play Now,” as was the case with representations 606 and 608 and/or the link representations on the originally received webpage) to imply that a selection of the representations may cause the corresponding media items to be played by one or more playback zones in the media playback system.

In yet another example, the representation associated with the link may be in the form of a representative icon proximal to the link representation on the originally received webpage indicating the option to cause the media item to be played in the one or more playback zones. FIG. 6D shows the webpage 600 with content 602 similar to that shown in FIGS. 6A and 6C. In this example, however, representation 606 and 608 may still be displayed on the website 600, and the content 602 may further include representative icons 632 and 634. In this example, icon 632 may be associated with representation 606 and icon 634 may be associated with representation 608. In one case, the icon 632 and icon 634 may be merely informative, indicating that selections of the representation 606 and representation 608, respectively, may cause media items corresponding to the respective representations 606 and 608 to be played in the one or more playback zones. In another case, selections of the representations 606 and 608 may cause actions (such as launching media playback software to play the corresponding media items) similar to that if the same associated link representations were selected in the originally receive webpage. However, in this case, the icons 632 and 634 may be selectable to cause the corresponding media items to be played in the one or more playback zones of the media playback system. Other examples that are not shown or discussed are also possible.

Referring back to method 500 in FIG. 5, block 508 involves displaying a list of the one or more playback zones of the media playback system in response to a first input. The one or more playback zones of the media playback system are the one or more playback zones identified at block 502. In the examples shown in FIGS. 6A and 6B, the first input may be a selection of “Play to Media System” or “Queue to Media System” in the options 610. In the example shown in FIG. 6C, the first input may be a selection of the representation 606′ or 608′, and in the example shown in FIG. 6D, the first input may be a selection of the representative icons 632 or 634. In each of the above examples, a playback zones list 612 may be displayed in response to the first input.

As shown, the playback zones list 612 may include “Playback Zone 1,” “Playback Zone 3,” and “Playback Zone 4.” In one example, the playback zones in the list 612 may be ordered according to alphabetical order of the zone names. In another example, the playback zones in the list 612 may be ordered chronologically according to when each playback zone was created or when each playback zone most recently played media content. In yet another example, the playback zones in the list 612 may be ordered according to physical proximities between the computing device providing the web-browsing interface and the respective one or more playback zones. For instance, if a user is using the web-browsing interface on a tablet or personal computer in “Playback Zone 3”, then “Playback Zone 3” may be listed first. In a further example, if the one or more playback zones were identified based on information retrieved from the controller software application for the media playback system, a playback zone that is currently being accessed via the controller software application running on the web-browsing interface device may be listed first. Other examples are also possible.

In addition, the playback zones in the list 612 may be listed or ordered according to playback states of the playback zones. For instance, playback zones that are not currently playing any media content may be listed first. Along the same lines, an icon or some other graphical effect may be provided in the playback zones list 612 to indicate that certain playback zones are currently playing media content, and other playback zones are not. In some cases, playback zones that are currently playing media content may not be available to play media items from the webpage 600 or 650. In one case, the unavailable playback zone may be grayed out and/or non-selectable. In another case, the unavailable playback zone may not be included in the list 612 at all. In addition to those described and/or suggested above, other selectable representations may be provided while maintaining the same or similar functionalities of playing the corresponding media item or prompting for additional input from the user are also possible.

At block 510 in FIG. 5, the method 550 involves causing a particular playback zone of the media playback system to play the playable media item in response to a second input. In one example, the second input may involve a selection of the particular playback zone from the list of the one or more playback zones. Upon the selection of the particular playback zone, the link to the media item corresponding to the representation selected as part of the first input at block 506 may be sent to the media playback system to be played in the particular playback zone. In one example, the link may be sent to a playback device in the particular playback zone.

As indicated above, the media item may be added to a playback queue associated with the particular playback zone, in addition to, or instead of causing the playback zone to play the media item immediately. In particular, if “Queue to Media System” in options 610 was selected in the examples shown in FIGS. 6A and 6B, the media item is first added to the associated playback queue before the media item may be subsequently played by the particular playback zone. Other examples are also possible.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

As indicated above, the present application involves facilitating playback of media items on a webpage by a playback zone of a media playback system. In one aspect, a method is provided. The method involves identifying one or more playback zones of a media playback system upon opening a web-browsing interface, identifying on a webpage, a link to a playable media item, and modifying the webpage such that a representation associated with the link is selectable to cause the media item to be played in the one or more playback zones.

In another aspect, a device is provided. The device includes a processor, and memory having stored thereon instructions executable by the processor to cause the device to perform functions. The functions include identifying one or more playback zones of a media playback system upon opening a web-browsing interface, identifying on a webpage, a link to a playable media item, and modifying the webpage such that a representation associated with the link is selectable to cause the media item to be played in the one or more playback zones.

In yet another aspect, a non-transitory computer readable memory is provided. The non-transitory computer readable memory has stored thereon instructions executable by a computing device to cause the computing device to perform functions. The functions include identifying one or more playback zones of a media playback system upon opening a web-browsing interface, identifying on a webpage, a link to a playable media item, and modifying the webpage such that a representation associated with the link is selectable to cause the media item to be played in the one or more playback zones.

The present application further involves playing media items on a webpage in a playback zone of a media playback system. In one aspect, a method is provided. The method involves displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The method also involves causing the particular playback zone to play the media item responsive to a second input indicating a selection of a particular playback zone in the list of one or more playback zones.

In another aspect, a device is provided. The device includes a processor, and memory having stored thereon instructions executable by the processor to cause the device to perform functions. The functions include displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The functions also include causing the particular playback zone to play the media item responsive to a second input indicating a selection of a particular playback zone in the list of one or more playback zones.

In yet another aspect, a non-transitory computer readable memory is provided. The non-transitory computer readable memory has stored thereon instructions executable by a computing device to cause the computing device to perform functions. The functions include displaying on a web-browsing interface, a representation associated with a link to a media item, and responsive to a first input indicating a selection of the representation, displaying a list of one or more playback zones in a media playback system. The one or more playback zones are identified upon, or subsequent to a launching of the web-browsing interface. The functions also include causing the particular playback zone to play the media item responsive to a second input indicating a selection of a particular playback zone in the list of one or more playback zones.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. At least one non-transitory computer-readable medium comprising program instructions that are executable by at least one processor such that a computing device is configured to:
render, via a web browser executing on the computing device, a web music player interface for selecting media items of a streaming audio service, the web music player interface comprising a plurality of links, wherein the plurality of links comprises first links selectable to play back respective media items from one or more servers of the streaming audio service, wherein the computing device is connected to a local area network, and wherein the one or more servers are outside of the local area network;
identify, via the web browser, playback devices connected to the local area network;
responsive to selection of a particular link from among the plurality of links, modify the web music player interface to display second links in a list, wherein the second links correspond to respective playback devices and are selectable to select among the identified playback devices for playback;
responsive to selection of a particular second link corresponding to a particular playback device, cause a playback queue to be associated with the particular playback device; and
cause, via a network interface, the particular playback device to play back the playback queue.

2. The at least one non-transitory computer-readable medium of claim 1, wherein the at least one non-transitory computer-readable medium further comprises program instructions that are executable by the at least one processor such that the computing device is configured to:
responsive to selection of a particular first link, add a particular media item corresponding to the particular first link to the playback queue.

3. The at least one non-transitory computer-readable medium of claim 1, wherein the at least one non-transitory computer-readable medium further comprises program instructions that are executable by the at least one processor such that the computing device is configured to:
responsive to selection of the particular second link corresponding to the particular playback device, cause the particular playback device to start playback of the playback queue.

4. The at least one non-transitory computer-readable medium of claim 1, wherein the program instructions that are executable by the at least one processor such that the computing device is configured to cause the particular playback device to play back the playback queue comprise program instructions that are executable by the at least one processor such that the computing device is configured to:
cause, via the network interface, the particular playback device to initiate streaming of at least one media item of the playback queue from the one or more servers of the streaming audio service.

5. The at least one non-transitory computer-readable medium of claim 1, wherein the program instructions that are executable by the at least one processor such that the computing device is configured to identify, via the web browser, the playback devices connected to the local area network comprise program instructions that are executable by the at least one processor such that the computing device is configured to:
identify, via the web browser, the playback devices connected to the local area network responsive to selection of the particular link from among the plurality of links.

6. The at least one non-transitory computer-readable medium of claim 1, wherein the program instructions that are executable by the at least one processor such that the computing device is configured to identify, via the web browser, the playback devices connected to the local area network comprise program instructions that are executable by the at least one processor such that the computing device is configured to:
identify, via the web browser, the playback devices connected to the local area network responsive to rendering of the web music player interface.

7. The at least one non-transitory computer-readable medium of claim 1, wherein the program instructions that are executable by the at least one processor such that the computing device is configured to identify, via the web browser, the playback devices connected to the local area network comprise program instructions that are executable by the at least one processor such that the computing device is configured to:
discover, via the network interface, the playback devices according to one or more network streaming protocols.

8. The at least one non-transitory computer-readable medium of claim 1, wherein the program instructions that are executable by the at least one processor such that the computing device is configured to identify, via the web browser, the playback devices connected to the local area network comprise program instructions that are executable by the at least one processor such that the computing device is configured to:
identify one or more playback devices that are associated with a user account that is logged into the web music player interface.

9. The at least one non-transitory computer-readable medium of claim 8, wherein the program instructions that are executable by the at least one processor such that the computing device is configured to identify the one or more playback devices that are associated with the user account that is logged into the web music player interface comprise program instructions that are executable by the at least one processor such that the computing device is configured to:
identify at least one playback device that is outside of the local area network in addition to the playback devices connected to the local area network.

10. The at least one non-transitory computer-readable medium of claim 1, wherein the web music player interface further comprises respective metadata and album art of the media items.

11. A method to be performed by a computing device, the method comprising:
rendering, via a web browser executing on the computing device, a web music player interface for selecting media items of a streaming audio service, the web music player interface comprising a plurality of links, wherein the plurality of links comprises first links selectable to play back respective media items from one or more servers of the streaming audio service, wherein the computing device is connected to a local area network, and wherein the one or more servers are outside of the local area network;
identifying, via the web browser, playback devices connected to the local area network;
responsive to selection of a particular link from among the plurality of links, modifying the web music player interface to display second links in a list, wherein the second links correspond to respective playback devices and are selectable to select among the identified playback devices for playback;
responsive to selection of a particular second link corresponding to a particular playback device, causing a playback queue to be associated with the particular playback device; and
causing, via a network interface, the particular playback device to play back the playback queue.

12. The method of claim 11, further comprising:
responsive to selection of a particular first link, adding a particular media item corresponding to the particular first link to the playback queue.

13. The method of claim 11, further comprising:
responsive to selection of the particular second link corresponding to the particular playback device, causing the particular playback device to start playback of the playback queue.

14. The method of claim 11, wherein causing the particular playback device to play back the playback queue comprises:
causing, via the network interface, the particular playback device to initiate streaming of at least one media item of the playback queue from the one or more servers of the streaming audio service.

15. The method of claim 11, wherein identifying, via the web browser, the playback devices connected to the local area network comprises:
identifying, via the web browser, the playback devices connected to the local area network responsive to selection of the particular link from among the plurality of links.

16. The method of claim 11, wherein identifying, via the web browser, the playback devices connected to the local area network comprises:
identifying, via the web browser, the playback devices connected to the local area network responsive to rendering of the web music player interface.

17. The method of claim 11 The method of claim 11, wherein identifying, via the web browser, the playback devices connected to the local area network comprises:
discovering, via the network interface, the playback devices according to one or more network streaming protocols.

18. The method of claim 11, wherein identifying, via the web browser, the playback devices connected to the local area network comprises:
identifying one or more playback devices that are associated with a user account that is logged into the web music player interface.

19. The method of claim 18, wherein identifying the one or more playback devices that are associated with the user account that is logged into the web music player interface comprises:
identifying at least one playback device that is outside of the local area network in addition to the playback devices connected to the local area network.

20. A computing device comprising:
a network interface,
a display;
at least one processor; and
at least one non-transitory computer-readable medium comprising program instructions that are executable by the at least one processor such that the computing device is configured to:
render, via a web browser executing on the computing device on the display, a web music player interface for selecting media items of a streaming audio service, the web music player interface comprising a plurality of links, wherein the plurality of links comprises first links selectable to play back respective media items from one or more servers of the streaming audio service, wherein the computing device is connected to a local area network, and wherein the one or more servers are outside of the local area network;
identify, via the web browser, playback devices connected to the local area network;
responsive to selection of a particular link from among the plurality of links, modify the web music player interface to display second links in a list, wherein the second links correspond to respective playback devices and are selectable to select among the identified playback devices for playback;
responsive to selection of a particular second link corresponding to a particular playback device, cause a playback queue to be associated with the particular playback device; and
cause, via the network interface, the particular playback device to play back the playback queue.
